(19) United States
(12) Patent Application Publication
(10) Pub. No.: US 2016/0281852 A1
(43) Pub. Date: Sep. 29, 2016

(54) Laminate Gasket with Woven Core

(71) Applicant: Interface Performance Materials, Inc., Lancaster, PA (US)

(72) Inventor: John S. Forry, Lancaster, PA (US)

(21) Appl. No.: 15/079,791

(22) Filed: Mar. 24, 2016

Related U.S. Application Data
(60) Provisional application No. 62/139,483, filed on Mar. 27, 2015.

(51) Int. Cl. F16J 15/10; B32B 37/20; B32B 5/02; B32B 37/24; B32B 38/10; B32B 3/26; B32B 38/08; B32B 38/00

(52) U.S. Cl. CPC F16J 15/104; F16J 15/102; F16J 15/108; B32B 38/08; B32B 37/20; B32B 38/0004; B32B 37/24; B32B 38/10; B32B 3/266; B32B 5/024; B32B 2038/0076; B32B 2037/243; B32B 2260/046; B32B 2305/076; B32B 2305/188; B32B 2315/085; B32B 2581/00; B32B 2307/54; B32B 2307/732; B32B 2307/724

(57) ABSTRACT

A laminate gasket for sealing between two opposing surfaces includes a core layer formed from a sheet of woven material having a first surface, a second surface opposite the first surface, and a binder material impregnating the sheet and at least partially coating both of the first and second surfaces. The laminate gasket also includes a first facing layer adhered to the first surface with the cured binder material and a second facing layer adhered to the second surface with the cured binder material to form a laminate base sheet, with each of the first facing layer and the second facing layer comprising a fiber composite material. The laminate gasket further includes one or more process apertures formed through the laminate base sheet and an edge seal formed around an inner edge of the process aperture to prevent interstitial leakage of the process fluid into the core layer.

### CROSS-REFERENCE TO RELATED APPLICATIONS

This application claims the benefit of U.S. Provisional Patent Application No. 62/139,483, filed Mar. 27, 2015, and entitled “Laminate Gasket with Woven Core,” which application is incorporated by reference in its entirety herein, and for all purposes.

### FIELD OF THE INVENTION

The present invention relates generally to gaskets for sealing between two opposing surfaces, such as mating metal flanges.

### BACKGROUND

Gaskets have long been used to seal interfaces between adjoining sections of pipe in piping systems and between components in complex machinery having sealed internal fluid passages. For example, in the process industries flange gaskets can be used to seal the joints between mating piping flanges, while in internal combustion engines head gaskets seal between the heads of an engine and the engine block, oil pan gaskets seal the interface between the oil pan and the block, and water pump gaskets seal around the ports of a water pump where the water pump is attached to the engine block. In addition, gaskets are often specifically designed for a particular intended use. For instance, head gaskets are designed to seal against the high pressures and temperatures and the generally caustic environment within the cylinders of an engine. On the other hand, water pump gaskets must seal against leakage of coolant, which may consist of a water and anti-freeze mixture, that is heated and pressurized. As known to those of skill in the art, many flange gaskets and machinery gaskets can be made from a compressible fibrous gasket sheet material that is die-cut to the required gasket shape.

In general, key performance characteristics required of most compressible gaskets include compression failure resistance, sealability, and tensile strength (for those applications with higher internal pressures than splash conditions). Compression failure resistance refers to the ability of a gasket to withstand high compression forces when clamped between two flange surfaces without crushing, deforming, or yielding to the point that the mechanical properties of the gasket material and ultimately the seal provided by the gasket are compromised. Sealability refers to a gasket's ability to resist or prevent leakage of service fluid between the outer surfaces of the gasket and the faces of the matting flanges that clamp the gasket, commonly referred to as “interfacial” leakage, as well as leakage through the gasket material itself, commonly referred to as “interstitial” leakage. And tensile strength refers to the gasket's capacity for resisting the pressure within the sealed container or piping system.

Fibrous gaskets can be formed from dried sheets of compressible fibrous or fiber composite material (e.g. fiber, filler, and a binder) that are die-cut into a desired shape having apertures. While fibrous gaskets can provide superior resistance to compression failure over other gasket materials, leakage can still be of particular concern. For example, the raw die-cut edges tend to be somewhat porous due to the nature of the fiber material, so that interstitial leakage can become a significant problem when the porous edges surrounding the apertures become exposed to the fluid being sealed. In addition, interfacial leakage can be caused by rough or warped flange surfaces, or by thin flanges and poor bolt placement that result in regions of substantially reduced compression stress on the gasket.

In general, the sealability of a porous gasket can often be enhanced by providing the surfaces of the gasket with a coating or by impregnating the pores in the gasket with a resin. Fibrous gaskets are likely to have such treatments since, in many cases, the porous material of the gasket is subject to interstitial and interfacial leakage as a result of the failure mechanisms discussed above. While coating and impregnation can improve the sealability of a fibrous gasket, unfortunately these treatments can also degrade its resistance to compression failure. This is because the coating and impregnating agents, which themselves exhibit good sealability but poor compression failure resistance, tend to penetrate beyond the pores and become absorbed into fibrous gasket material itself. This reduces the gasket's ability to function well under higher flange pressures where compression failure is more likely. As a result, coated and impregnated fibrous gaskets often perform poorly under high flange pressures, which severely limits the applications in which such gaskets can be used.

It will thus be appreciated that for fibrous and perhaps other types of compressible gaskets, sealability and compression failure resistance have heretofore been mutually incompatible gasket properties. In other words, measures taken to enhance the sealability of such gaskets inherently tend to reduce compression failure resistance and vice versa. As a result, manufacturers of gaskets, and particularly fibrous gaskets, have engaged in proverbial balancing acts in order to design and produce gaskets with acceptable sealability and also acceptable compression failure resistance for a particular application. The problem, of course, is that each of these properties necessarily becomes a compromise and neither is optimized.

In addition, the tensile strength of the fibrous gasket material is also an important consideration in applications where the gasket is tasked with sealing against high internal pressures. For example, a gasket's resistance to blowout failure is generally proportional to its resistance to bending and bulging in response to an increase in pressure within the sealed container or piping system. This is because the bending stiffness of the gasket is generally considered to be a function of the tensile strength and web thickness of the gasket material. Thus, for a given web thickness, an increase in tensile strength can directly increase the gasket's resistance to pressure-related failure. Unfortunately, it has been observed that the tensile strength of fiber composite gaskets can be prone to deterioration over time, so that even in applications where the tensile strength is initially adequate, the possibility exists for the tensile strength to drop sufficiently throughout its service lifetime to contribute to gasket failure.

A need therefore exists for an improved compressible fibrous gasket that retains the economy and wide application range of traditional fibrous gaskets and that also provides a superior and longer lasting seal. If possible, the properties of sealability and compression failure resistance should be de-coupled such that each can be optimized for a particular application without compromising the other. In addition, tensile strength should be maintained throughout the entire service life of the gasket. Such a gasket should exhibit excellent to complete sealability in a wide variety of joint types while at the same time having the highest possible resistance to compression failure and blow-out failure where such failures are possible. The failure modes associated with controlled compression rubber gaskets should be successfully addressed, as should problems with warped or rough flange surfaces. A method of fabricating such a gasket that is economical, efficient, and reliable is also needed. It is to the provision of such a gasket and fabrication method that the present invention is primarily directed.

### SUMMARY

Briefly described, one embodiment of the present disclosure comprises a laminate gasket for sealing between two opposing surfaces. The laminate gasket includes a core layer formed from a sheet of woven material having a first surface, a second surface opposite the first surface, and a binder material impregnating the sheet and at least partially coating both of the first and second surfaces. The laminate gasket also includes facing layers that are adhered to the first and second surfaces with the cured binder material to form a laminate base sheet, with each of the facing layers comprising a paper-like fiber composite material. The laminate gasket further includes one or more process apertures formed through the laminate base sheet and having an edge seal formed around an inner edge of the process aperture. The edge seal can operate to prevent interstitial leakage of the contained process or service fluid into the core layer, as well as interfacial leakage across the facing layers.

In accordance with another embodiment, a method of making a laminate gasket for sealing between two opposing surfaces includes the steps of obtaining a sheet of woven fiberglass fibers having a first surface and a second surface opposite the first surface, and impregnating the sheet with a wet binder material comprising an acrylic latex to at least partially coat the first and second surfaces. The method also includes applying a first facing layer formed from a fiber composite material to the first surface, applying a second facing layer formed from the fiber composite material to the second surface, and heating the sheet and applied first and second facing layers to a predetermined temperature for a predetermined time to cure the binder material and form a sheet of laminate gasket material. The method further includes cutting a laminate base sheet from the sheet of laminate gasket material having one or more process apertures and a plurality of bolt holes, forming an edge seal on an inner edge of the process apertures, and cutting away an outer portion of the laminate base sheet to complete the laminate gasket.

In one aspect the step of forming the edge seal further comprises stacking together a plurality of laminate base sheets while aligning their process apertures to define a cavity within the stack of laminate base sheets, introducing a flowable edge seal material into the cavity, and rotating the stack of laminate base sheets to deposit the edge seal material onto the inner edges of the process apertures. The method further includes removing the flowable edge seal material, separating the plurality of laminate base sheets, and heating the plurality of laminate base sheets to a predetermined temperature for a predetermined time to cure the edge seal material.

The invention will be better understood upon review of the detailed description set forth below taken in conjunction with the accompanying drawing figures, which are briefly described as follows.

### BRIEF DESCRIPTION OF THE DRAWINGS

FIG. 1 is a plan view of a laminate gasket for sealing between two opposing surfaces, in accordance with a representative embodiment of the disclosure.

FIG. 2 is a cross-section of the laminate gasket of FIG. 1, as viewed from section line A-A.

FIG. 3 is a close-up perspective view of a fiberglass cloth used for forming the laminate gasket of FIG. 1.

FIG. 4 is a schematic representation of a first portion of the process for making the laminate gasket of FIG. 1.

FIG. 5 is a block diagram of a second portion of the process for making the laminate gasket of FIG. 1.

FIGS. 6A-6H are cross-sections of the laminate gasket having a variety of edge seals, in accordance with additional representative embodiments.

FIG. 7 is a cross-section of the laminate gasket in which the edge seal material has penetrated into the woven core, in accordance with another representative embodiment.

FIG. 8 is a cross-section of a laminate gasket in which a face seal has been added to cover the facial surfaces of the edge seal, in accordance with yet another representative embodiment.

FIG. 9 is a cross-section of a laminate gasket in which a face seal has been combined with the protruding rims of the edge seal, in accordance with yet another representative embodiment.

Those skilled in the art will appreciate and understand that, according to common practice, various features of the drawings discussed below are not necessarily drawn to scale, and that dimensions of various features and elements of the drawings may be expanded or reduced to more clearly illustrate the embodiments of the present invention described herein.

### DETAILED DESCRIPTION

The following description, in conjunction with the accompanying drawings described above, is provided as an enabling teaching of exemplary embodiments of a laminate gasket with a woven core and one or more methods for making the laminate gasket. As described below, the laminate gasket can provide several significant advantages and benefits over other gaskets and/or methods of making gaskets. However, the recited advantages are not meant to be limiting in any way, as one skilled in the art will appreciate that other advantages may also be realized upon practicing the present disclosure.

Furthermore, those skilled in the relevant art will recognize that changes can be made to the described embodiments while still obtaining the beneficial results. It will also be apparent that some of the advantages and benefits of the described embodiments can be obtained by selecting some of the features of the embodiments without utilizing other features, and that features from one embodiment may be combined with features from other embodiments in any appropriate combination. For example, any individual or collective features of method embodiments may be applied to apparatus, product or system embodiments, and vice versa. Accordingly, those who work in the art will recognize that many modifications and adaptations to the embodiments described are possible and may even be desirable in certain circumstances, and are a part of the disclosure. Thus, the present disclosure is provided as an illustration of the principles of the embodiments and not in limitation thereof, since the scope of the invention is to be defined by the claims.

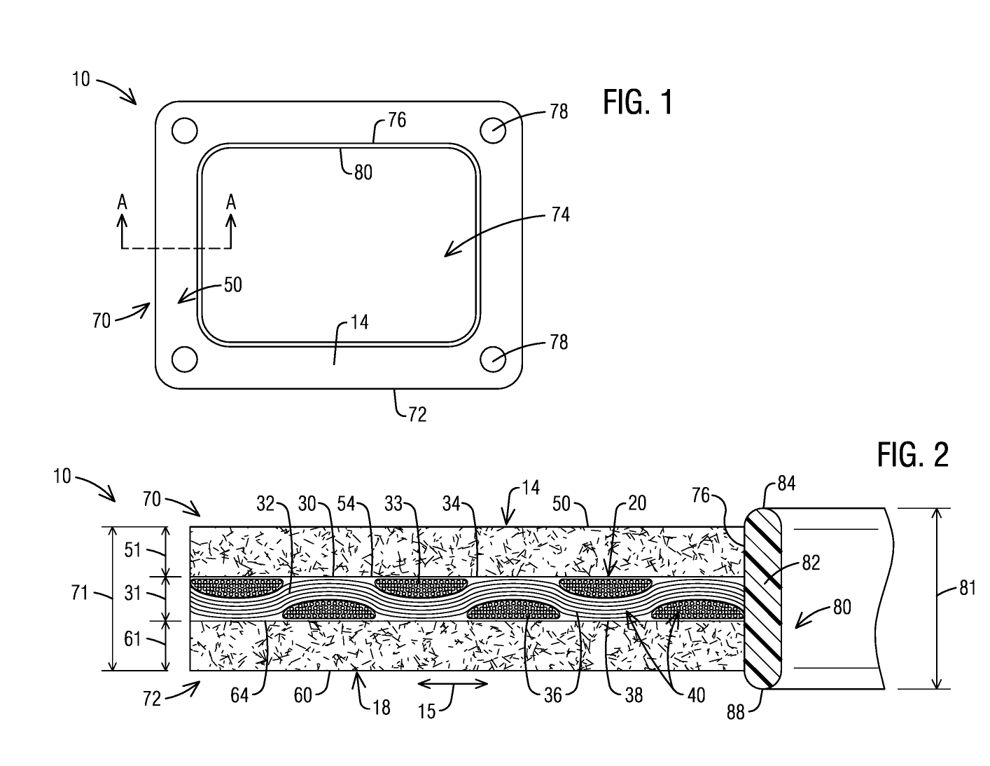

Referring now in more detail to the drawing figures, wherein like parts are identified with like reference numerals throughout the several views, FIGS. 1-3 illustrate a laminate gasket 10 for sealing a joint between two opposing and substantially planar surfaces, such as between the mating metal flanges in a piping system or between the machined edges of an opening into a casing (such as an engine block) and a removable headpiece or cover. As shown in the plan view of FIG. 1, the laminate gasket 10 includes one or more process apertures 74 through the thickness 11 thereof that allows for the internal passage of a process fluid across the joint. The laminate gasket 10 can also generally includes bolt holes 78 configured to receive fasteners for securing the two opposing surfaces together. Although depicted in FIG. 1 as having a basic polygonal shape for sealing around a simple flange or against a machined surface that surrounds an opening to a casing, it will be appreciated that the laminate gasket is not limited to this or any other shape. Indeed, the laminate gasket can be manufactured in a variety of shapes, sizes and configurations, and can also include multiple process apertures 74 so as to simultaneously seal separate process streams, such as, for example, motor oil and engine coolant.

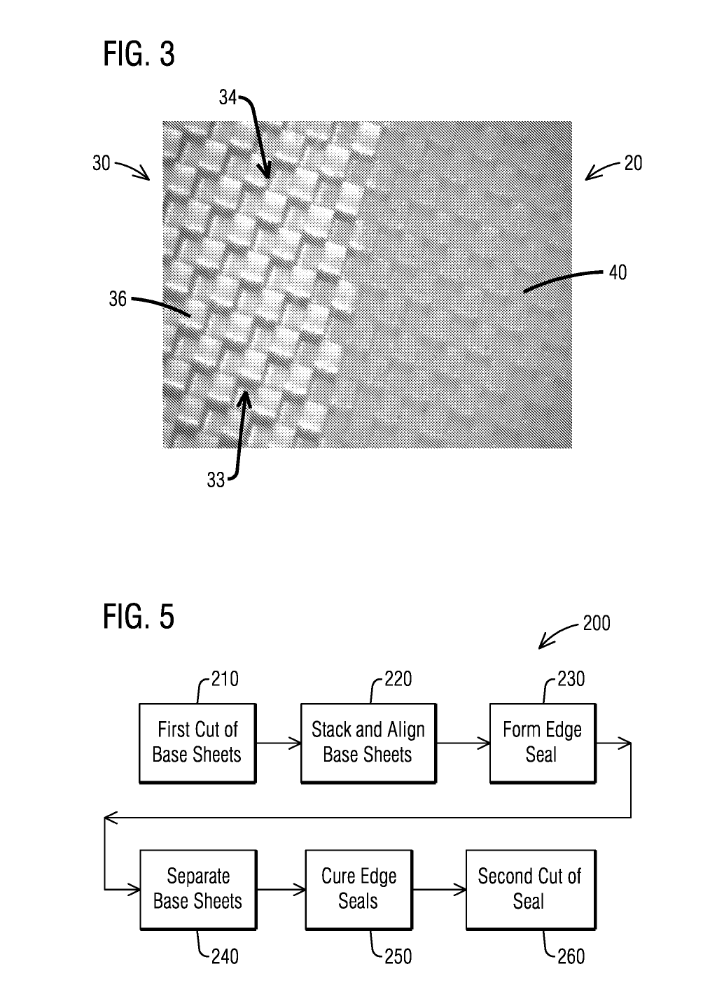

With reference to FIGS. 2-3, the laminate gasket 10 generally includes a core layer 20 formed from a compliant cloth or sheet 30 of woven fibers 32 having a first 34 or upper surface and a second 38 or lower surface that is opposite the first surface. The woven fibers 32 can be selected from a variety of fiber types, including but not limited to fiberglass fibers, carbon fibers, aramid fibers, cotton fibers, and polyester fibers. In one aspect the sheet 30 can comprise fiberglass fibers 33 that are bundled into ribbon-like threads or strands 36, with the strands 36 of bundled fiberglass fibers 33 being woven together to form a woven fiberglass cloth 30 that is compliant and bendable in an out-of-plane direction, yet which is substantially stiff and inelastic when pulled or stressed along the plane of the cloth 30. The strands 36 of bundled fiberglass fibers 33 can be woven together in a variety of patterns or weaves, such as the perpendicular and symmetric crisscrossing or over/under weave of the woven sheet 30 shown in FIGS. 2 and 3. It is to be appreciated that other types of woven sheets having strands or threads of bundled fibers woven together in non-perpendicular or non-symmetric patterns are also possible and considered to fall within the scope of the present disclosure.

The composition and weave of the woven fibers 32 can provide the core layer 20 of the laminate gasket 10 with desirable material properties or characteristics. For example, one particularly useful characteristic provided by the woven sheet 30 is the improved tensile strength of the gasket 10 in the in-plane direction for resisting the pressure within the sealed piping system or container. As known to one of skill in the art, the bending stiffness of a gasket is a function of the tensile strength and web thickness of the gasket material. Thus, for a given web thickness, an increase in tensile strength can directly increase the gasket's resistance to bulging in response to an increase in pressure within the sealed piping system or container, and ultimately result in an increase in the gasket's resistance to a blowout failure. With the laminate gasket 10 illustrated in FIGS. 1-3, for instance, the tensile strength provided by the sheet 30 of woven fiberglass fibers 33 that forms a portion of the core layer 20 can be greater than 10,000 psi, which is more than twice the tensile strength provided by many known gasket materials that typically have a tensile strength in the range of 1,000 to 5,000 psi.

The compliant sheet 30 of woven material or woven fibers 32 generally includes a thickness 31 that ranges between about 0.005 inch and 0.010 inch, and in a preferred embodiment can have a thickness 31 of about 0.007 inch to achieve the 10,000 psi tensile strength described above. In other applications with a greater mechanical demand, however, or embodiments where it may be desirable to provide the gasket with a stronger, more heavy-duty core layer that can hold greater pressures, it is contemplated that the woven sheet 30 can have a thickness that is greater than 0.010 inch, up to about 0.015 inch. Alternatively, it may also be possible to use a sheet 30 having a greater density of woven fibers 32 provided by a tighter weave or thicker fibers to achieve a comparable increase in tensile strength.

With reference to FIGS. 2 and 3, the sheet 30 of woven fibers 32 is impregnated with a binder material 40, in wet liquid or powder form, that is subsequently dried and/or cured to bind the fibers 32 together and thereby form the core layer 20. In a preferred embodiment the binder material 40 can be a wet, water-based acrylic latex, while in other embodiments the binder material can be a silicon-based adhesive or a resin type material such as a phenolic resin, an epoxy resin, a polyester-based material, and the like. During manufacture the binder material 40 can be applied through rolling, brushing, spraying, pouring, and the like onto one side of the sheet 30 in sufficient quantity so that the binder material flows or is wicked through the gaps between the strands 36 and/or between the individual fibers 32 bundled into strands 36 to at least partially, if not completely, coat the outer surfaces of the woven fibers 32 or strands 38 of woven fibers 33 that define both the first and second surfaces 34, 38 of the sheet 30. In other embodiments the binder material 40 can be applied to both surfaces and allowed to flow inward from both directions to complete the impregnation of the sheet 30.

After application of the binder material 40, a first facing layer 50 is applied to the first 34 or upper surface of the impregnated sheet 30 and a second facing layer 60 is applied to the second 38 or lower surface that is opposite the first surface. The first facing layer 50 and the second facing layer 60 can comprise pre-fabricated sheets of fibrous or paper-like facing material formed from a homogenous mixture of reinforcing fibers, a facing material binder, and one or more fillers, with each being included in proportional amounts. Examples of such materials that are commercially available include gasket sheet materials marketed under the trade names Synthaseal®, Pro-Formance®, and MicroPore®. Although a wide range of proportional amounts are possible, facing materials having at least 1% by weight of a facing material binder, such as natural or synthetic rubber latex, polymer-based binders, silicone-based binders, and the like, and at least 5% by weight of fiber have been found to be acceptable. Fillers, such as clays, can be added at a minimum level of about 1% by weight. Suitable ranges for these components include a range of from about 3% to about 40% by weight of binder, from about 5% to about 70% by weight of fiber, and, where applicable, from about 1% to about 92% by weight of filler. The reinforcing fibers can comprise any of aramid fibers, polyester fibers, cellulosic fibers, fiberglass fibers, or the like. In one embodiment the facing material mixture can comprise about 15%-20% rubber latex binder and about 20% reinforcing fibers, with the remainder of the mixture comprising fillers.

As the above materials are generally low in cost, the fibrous facing layers 50, 60 can be economical to manufacture while providing the laminate gasket 10 with a compression resistant exterior structure that supports and protects the woven core 20 when compressed within the joint. The facing layers 50, 60 can both have a thickness 51, 61 that is equal to or greater than the thickness of core layer 20. With the laminate gasket 10 illustrated in FIGS. 1-3, for example, the thickness of the facing layers 50, 60 can range between about 0.006 inch and 0.015 inch, and in a preferred embodiment can be about 0.010 inch. Generally, the thickness of the facing layers 50, 60 is controlled to provide the completed sheet of laminate gasket material with sufficient thickness for mounting an edge seal around the inner edge of a process aperture, as discussed in more detail below. Moreover, because of their compressibility, the thickness of the facing layers may also be adjusted to better distribute compressive loads away from the bolt areas after the assembly of the gasket within the sealed joint.

The facing layers 50, 60 can be pressed into the wet core layer 20 during their application, such as with a pair of pinch rollers, to ensure that the binder material 40 is evenly distributed throughout the woven sheet 30 and substantially coats the interior contact surfaces 54, 64 of both facing layers 50, 60. The pressing of the facing layers 50, 60 can also ensure that substantially continuous contact is established between their interior contact surfaces 54, 64 and the first and second surfaces 34, 38 of the woven sheet 30 prior to the curing of the binder material 40.

After application of the facing layers 50, 60 to the impregnated sheet 30, the layered composite material is then passed through an oven or similar drying apparatus to dry and cure the binder material 40. Curing the binder material 40 acts to bind and secure the woven fibers 32 together to form a stronger woven structure, and to bond the facing layers 50, 60 to either side of the woven sheet 30 to form a sheet of laminate gasket material 72. In addition, the cured core layer 20 formed from the cured binder material 40 and woven fibers 32 can be substantially incompressible, so as to provide the laminate gasket 10 with a resistance to compression failure that approaches the compression resistance of gaskets having solid metal cores.

During the development of the laminate gasket 10, the inventor discovered that the core layer 20 can remain substantially porous and pervious to fluids both during and after the curing of the binder material 40. While the permeability of a core layer of a gasket after curing would generally be considered a significant failure in gasket design, it has been determined that this unexpected continued permeability of the core layer 20 during the heated curing process can allow the water content of the binder material 40 to escape as water vapor or steam through the core layer 20 and out through the side edges of the laminate gasket material 72, rather than being absorbed or conveyed through the facing layers 50, 60. It is contemplated that this escape path for the heated water vapor can substantially reduce the time needed to cure the binder material 40 while diminishing or eliminating the formation of small bubbles or blisters at the interface between the core layer 20 and facing layers 50, 60 that could negatively impact the bond between the layers. As a result, the laminate bond between the core layer 20 and facing layers 50, 60 can be substantially stronger than the connection that would typically obtained with a non-porous core layer using a similar short-duration curing period.

Nevertheless, adequate bonding may still be obtained with a non-porous core layer, especially if the duration of the curing period is extended to allow additional time for the moisture within the binder material to be absorbed and/or conveyed through the facing layers 50, 60. Accordingly, non-porous core layers may also be considered to fall within the scope of the present disclosure.

Upon completion of the lamination process described above, the sheet of laminate gasket material 72 can be transported to a cutting and edge seal process in which the shaped base sheet 70 for the gasket 10 and one or more process apertures 74 and bolt holes 78 are cut out from the sheet of laminate gasket material 72. An edge seal 80 is then applied to the inner edge 76 of the process aperture(s) 74. The edge seal 80 or coating generally comprises an elastomeric material 82 that is selected or formulated to provide the necessary thermal stability and to be resistant to chemical attack or degradation by the particular service fluid that is to be sealed by the gasket, to be substantially impervious to such fluid, and to form a seal when compressed between the pair of metal flanges or opposing surfaces to prevent interstitial leakage of the contained process or service fluid into the core layer 20.

The edge seal 80 can generally comprises a rubber latex- or polymer-based elastomeric material 82. However, as flange conditions and service fluids to be sealed can vary considerably, the edge seal can also be formed from a wide variety of suitable materials. For instance, such materials include fusible powders, solid-filled polymers, and 100% solid fluids. Latex and/or elastomeric materials as well as silicone-based or rubber-based materials are preferred under some conditions. Specific preferred materials include, but are not limited to, organic, inorganic, and inorganic/organic hybrid polymers as well as filled polymers. Other polymeric coatings may include, but are not limited to, materials such as acrylic, acrylonitrile, acrylonitrile butadiene rubber NBR, fluoro polymers, hydrogenated NBR, styrene butadiene polymer, fluoroelastomer polymer, acrylic-acrylonitrile polymers, carboxylated acrylonitrile polymer, carboxylated styrene butadiene polymer, polyvinylidene chloride, chloroprene rubber polymer, ethylene propylene rubber polymer, ethylene/vinyl acetate polymer, epoxy, fluorosilicones, polyurethane, and silicone rubber. Each of the above materials may be UV curable, heat curable, or room temperature curable, or may require combinations of curing techniques. A polymeric coating may include a variety of fillers such as, for example, silica, carbon black, or clay to provide material properties adapted to a particular fluid or condition to be sealed. Polymeric powders that are heat fusible onto the faces and/or edges of the gasket base sheet also are acceptable and may be preferable for certain types of gaskets. Different, more exotic, or custom formulated materials now known or yet to be developed may be substituted for these preferred coating materials within the scope of this invention. Thus, while preferred materials are disclosed, the invention is not and should not be considered to be limited to the disclosed materials. Any material capable of providing the disclosed sealing properties is intended to be included within the scope of the present disclosure.

The edge seal 80 is bonded to the inner edges of the core layer 20 and both facing layers 50, 60, and serves to prevent the process fluid contained within the process aperture 74 from passing into the porous core layer 20. In one aspect the edge seal 80 can have a height 81 that is greater than the thickness 71 of the laminate gasket material 72, so that both an upper protruding rim 84 and a lower protruding rim 88 project outwardly beyond the upper surface 14 and lower surface 18 of the gasket 10 to contact the substantially planar opposing surfaces of the sealed joint (not shown). As may be appreciated by one of skill in the art, the protruding rims 84, 88 of the edge seal 80 can be compressed inward and flattened during the closing of the joint until the opposing surfaces contact the facing layers 50, 60, and which point the edge seal material 82 can become suitably compressed to form a reliable seal around the inner edge 76 of the process aperture 74.

It has been determined that the laminate gasket 10 illustrated in FIGS. 1-2 can provide an improved performance over other similarly-sized gaskets in similar applications. For example, in one test the inventor determined that a comparable edge seal-type gasket formed from a best-available, non-laminate fibrous gasket sheet material suffered from blow-out failure when the internal pressure of the sealed process or service fluid reached about 300 psi. In contrast, the laminate gasket 10 with a woven core 20 was able to maintain a reliable seal up to about 550 psi without indication of interfacial or interstitial leakage. Without being bound to any particular theory, it is thought that this improvement in containment performance of the gasket 10 is primarily due to the increased tensile strength of the laminate gasket material 70 that is provided by the woven and bound fibers of the core layer 20.

It has also been determined that the bond between the core layer 20 and the facing layers 50, 60 can be very strong and resistant to deterioration both over time and in the presence of heat. Accordingly, the propensity for the different layers of the laminate gasket material 72 to delaminate and fail during use is greatly reduced, and the useful life of a gasket 10 formed from the laminate material 72 can be substantially extended. Moreover, given that the cost of the materials and the manufacturing tooling used to manufacture the laminate gasket 10 is relatively low when compared to other gasket manufacturing processes, it is further anticipated that these and other advantages can be achieve with a substantial reduction in manufacturing costs.

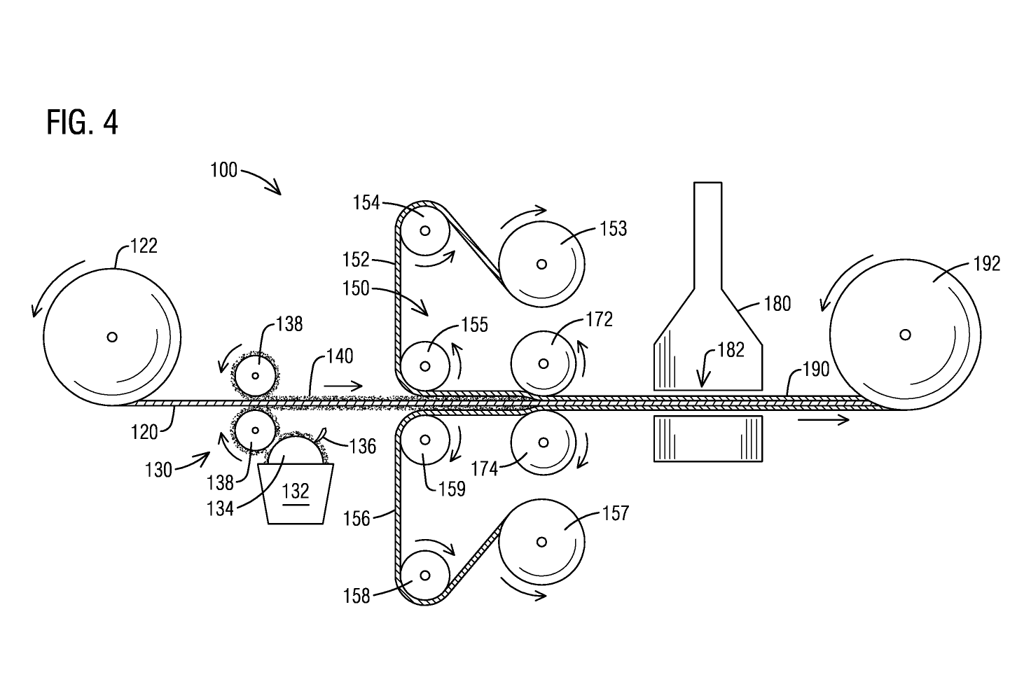

FIG. 4 is a schematic representation of a first portion 100, or lamination line, of a method for making the laminate gasket, in accordance with another representative embodiment. The lamination portion 100 of the method generally includes withdrawing a sheet 120 of woven fibers from a storage reel 122 and coating the woven sheet 120 with a liquid binder material. As shown in the drawing, in one aspect the wet binder material can be applied with a roll coat apparatus 130 in which a volume of liquid binder material is maintained in a receptacle 132, with a portion of the binder material being continuously picked up and transferred through a series of rollers 134, 138 to one or both sides of the woven sheet 120. The roll coat apparatus 130 can include a knife edge 136 that determines the amount of binder material that is carried to the application rollers 138.

The woven sheet 130 impregnated with binder material becomes a wet core layer 140 that is then passed through a facing layer application station 150. In the facing layer application station 150, an upper facing layer 152 and a lower facing layer 156, both being withdrawn from their respective storage reels 153, 157, can be fed around idler or tension rollers 154, 158 and then pushed against the wet core layer 140 with application rollers 155, 159 to form a composite laminate sheet 160. In some aspects the application rollers 155, 159 can be configured to drive the facing layers 152, 156 into the wet core layer to ensure that the binder material is evenly distributed throughout the wet core layer 140 and substantially coats the interior surfaces of both facing layers 152, 156, and that substantially continuous contact is established between the interior surfaces of the facing layers 152, 156 and the outer surfaces of the wet core layer 140. In other aspects the primary function of the application rollers 155, 159 can be to position the facing layers 152, 156 against the wet core layer 140 while a separate set of pinch rollers 172, 174 are used to drive the facing layers 152, 156 into the wet core layer 140.

The composite laminate sheet 160 is then fed into the interior 182 of a drying oven 180 having a temperature set to a predetermined value, and for a predetermined period of time, to dry and cure the binder material. For a binder material comprising an acrylic latex, the predetermined temperature can be about 350° F. and the predetermined time can be about 5 minutes. However, other curing times and temperatures are possible and likely depending upon the thickness and insulating properties of the facing layers 152, 156, the thickness and density of the woven sheet 120, and the composition of the binder material. After passing through the drying oven 180, the sheet 190 of laminate gasket material can be wound onto a take-up reel 192 for subsequent storage and/or transportation to an additional processing station for cutting out gasket blanks, or laminate base sheets, from the sheet 190 of laminate gasket material 190 and applying an edge-coating to the interior edges of the process apertures to complete the manufacture of the laminate gaskets.

A second portion 200, or edge-coating line, of the method for making the laminate gasket is shown schematically in the block diagram of FIG. 5. The edge-coating portion 200 of the method can begin with a first cutting 210 of laminate base sheets from the sheet 190 of laminate gasket material (FIG. 4). The internal features of the laminate base sheets generally include one or more process apertures and a plurality of bolt holes, which can be similar to the process apertures 74 and bolt holes 78 found in the laminate gasket 10 illustrated in FIG. 1. The first cutting 210 can be performed with a standard die cutting press that precisely cuts or punches through the laminate gasket material to define the process apertures and the bolt holes and the spatial relationship therebetween, while leaving the outer edges of the laminate base sheets substantially larger than their intended final dimensions. The additional material at the outer portions of the laminate base sheets can allow for easier handling of the base sheets throughout the edge-coating process 200.

After the cutting of the process apertures and bolt holes, a plurality of laminate base sheets can be aligned and tightly stacked together 220 so that their process apertures form a single cavity having the outer contours of the process apertures and the depth determined by the number of laminate base sheets in the stack. According to one preferred methodology, the laminate base sheets are stacked atop a plate having a shallow well formed therein, with the well having a shape corresponding to the shape of the gasket aperture and being aligned with the cavity defined by the process apertures. An edge seal or edge coating material, such as the rubber latex- or polymer-based elastomer described above, in liquid form is placed in the well and the cavity is closed off. The entire assembly is then tilted on edge and rotated at a predetermined relatively slow rate and through a predetermined number of revolutions. During rotation, the liquid edge seal material flows around the perimeter of the cavity and contacts the exposed edges of the stacked laminate base sheets.

As the edge seal material flows around the perimeter of the cavity over and over again, it gradually solidifies and builds up on the edges of the laminate base sheets to form 230 an edge seal coating on the walls of the cavity 2. When a sufficient number of revolutions have been completed to build up a soft, solidified coating of a desired thickness, the assembly is tilted back down to allow excess edge seal material to drain back into the shallow well of the plate, whereupon the stack can be removed.

After allowing the edge seal material coating to thicken partially but not completely, the individual laminate base sheets are peeled off and separated 240 the stack. Since the edge seal material is only partially thickened and thus still malleable, the peeling of each laminate base sheets causes the edge seal material on the gasket's edge to stretch and deform rather like soft taffy, which results in an edge seal that projects beyond the facial planes of the gasket to form the opposed protruding rims. The edge seals are then fully thickened in a second oven or otherwise cured 250 for at a second predetermined temperature and for a second predetermined time to set the final shape and physical properties of the edge seal. For a rubber latex-based edge seal material, the second predetermined temperature can be about 350° F. and the second predetermined time can be about 30 minutes.

In a final step, the laminate base sheets can be passed through a second cutting machine or cutting die press 260 to remove the excess material that surrounds the interior features and define the outer dimensions and shape of the completed gasket.

In an alternative methodology referred to herein as a “mold-in-place” process, the laminate base sheets can be stacked with their process apertures aligned as above but with one or more spacers disposed between the laminate base sheets. The walls of the cavity formed by the stack can then be coated with the liquid edge seal material as described above. The spacers have apertures that can be slightly smaller or slightly larger than the process apertures of the laminate base sheets. If a spacer with a slightly larger aperture is disposed between each laminate base sheet, a narrow gap is formed between each sheet and edge seal material flows a slight distance onto the faces of each laminate base sheet to form overlapped face coatings surrounding the process apertures of the gaskets. Spacers with smaller apertures can produce edge seals that do not project beyond the facial planes of the gasket. A precisely molded wrapped edge seal can be formed by stacking a larger aperture, then a smaller aperture, then another larger aperture spacer between each of the laminate base sheets of gasket material. In either event, edge seals are formed on or around the inner edges of the process apertures.

Alternative methodologies for coating the interior edges of the process apertures of the stacked laminate base sheets are also envisioned and form part of the invention. These alternative methodologies include a “stack-and-fill” process wherein the laminate base sheets are stacked and the cavity formed by their aligned process apertures is filled with the liquid edge seal material. After a predetermined time, the edge seal material is drained or poured out of the cavity, leaving a coating on the interior edges of the gaskets. Other methodologies include a “stack-and-spray” process wherein the edge seal material is sprayed onto the interior edges of the stacked laminate base sheets, and a “stack-and-wipe” process wherein the edge seal material is wiped or spread onto the interior edges with a squeegee or other appropriate tool. These and other methodologies are encompassed by the stack-and-coat process 200 described herein.

A more complete description of the above stack-and-coat, mold-in-place and additional processes for forming edge seals around the inner edges of process apertures can be found in co-owned U.S. Pat. No. 6,626,439 that issued on 30 Sep. 2003, and which patent is incorporated by reference in its entirety herein.

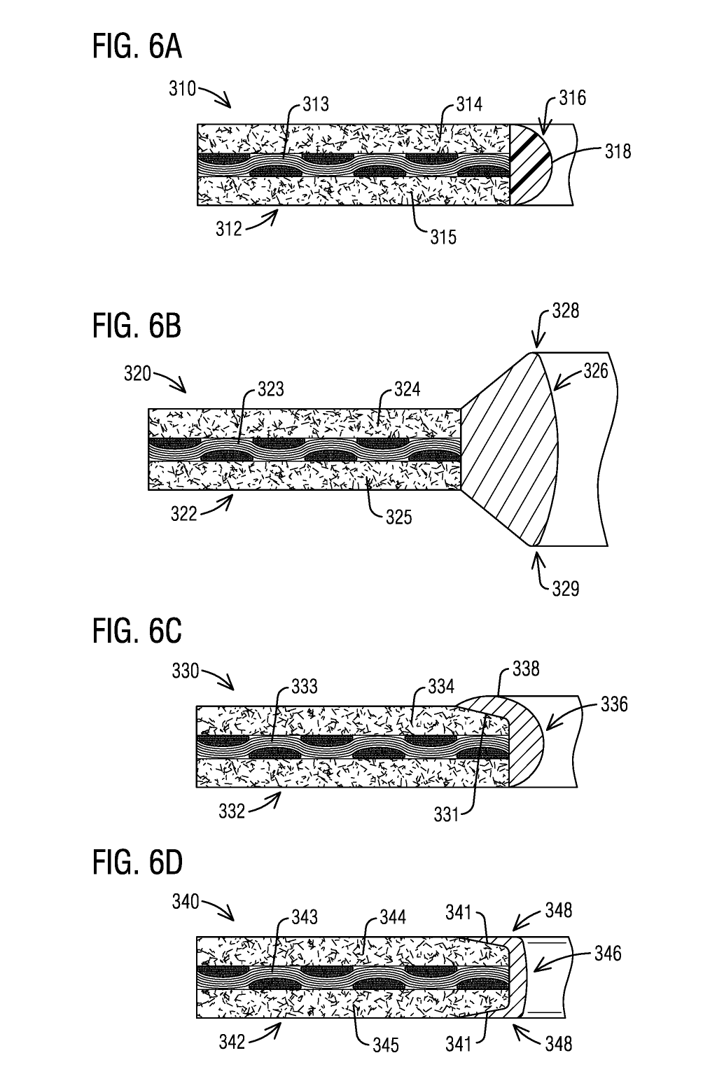

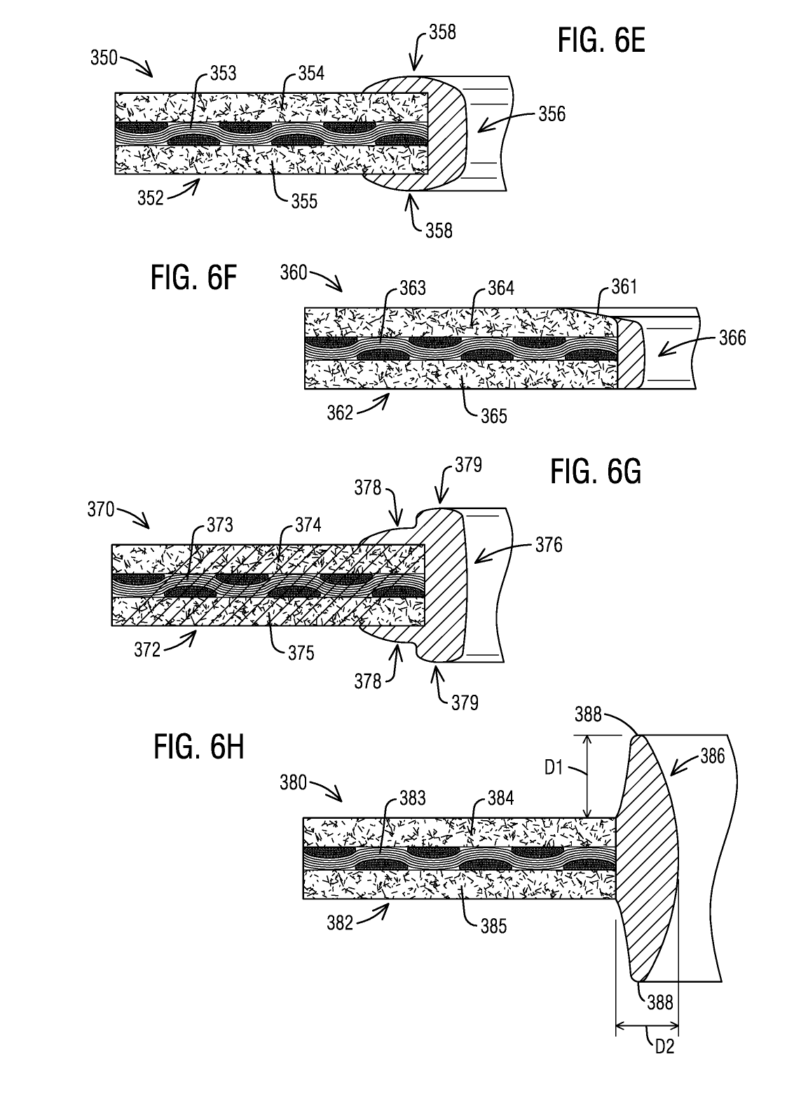

As alluded to above and shown in FIGS. 6A-6H, the edge seal of the laminate gasket is not limited to oblong shape with protruding upper and lower rims shown in FIG. 2. For example, FIG. 6A illustrates a laminate gasket 310 with a woven core layer 313 and an edge seal 316 having a semi-circular shape with a central portion 318 that is substantially thicker than at its edges. In this embodiment, the edge seal 316 can have a width that is substantially the same as the thickness of the laminate base sheet 312 so that the rims of the edge seal lie substantially in and do not protrude beyond the outer surfaces of the facing layers 314, 315. When the gasket of FIG. 6A is clamped between mating surfaces, the edge seal 316 seals against interstitial leakage and is slightly compressed along with the laminate base sheet 312 such that a relatively broad area of the edge seal 316 engages the flanges to seal against interfacial leakage. However, since there are no protruding rims in the laminate gasket 310, the edge seal 316 may not to conform well to flange surface imperfections and roughness. Accordingly, the laminate gasket 310 may be preferred for use with rigid, smooth, and flat flange surfaces.

FIG. 6B illustrates a laminate gasket 320 with a woven core layer 323 and an edge seal 326 having an inwardly rounded convex interior face and that extends beyond the outer surfaces of the facing layers 324, 325 of the laminate base sheet 312 to protruding rims 328, 329 that extend around the process aperture of the gasket 320. The edge seal 326 is thus thicker in its central region than around its rims 328, 329. Although many dimensions may be acceptable depending upon a particular intended application for the gasket, it has been found that the rims 328, 329 of the edge seal may protrude beyond the outer surfaces of the facing layers 324, 325 a distance of from about 0.001 inch to about 0.040 inch, depending on the size and configuration of the gasket and its intended application to obtain superior sealability around the aperture of the laminate gasket 320.

FIG. 6C illustrates a laminate gasket 330 with a woven core layer 333 and a depressed region 331 in the upper facing layer 334 proximate to and surrounding the aperture of the gasket. The depressed region 331 is configured as a relatively narrow strip surrounding the aperture and reduces the width of the interior edge of the laminate base sheet 332 to a width less than the thickness of the laminate base sheet 332. The depressed region 331 may be formed intentionally in the facing material through sanding or shaving techniques or may simply be an artifact of the die-cutting process. The edge seal 336 in this embodiment is generally bulbous in shape and wraps around to cover the depressed region 331 in the upper facing layer 334. A portion of the edge seal 336 protrudes beyond the outer surface of the upper facing layer 334 to form a protruding rim 338 surrounding the aperture of the laminate gasket 330 on one side thereof. The protruding rim 338 generally overlies the depressed region 331, although this is not necessarily a requirement. The protruding rim 338 can provide extra sealability upon contact with an adjacent flange when the gasket is compressed between two flanges or other mating surfaces. The protruding portion may extend from about 0.001 inch to about 0.040 inch beyond the outer surface of the upper facing layer 334 depending upon the size, configuration, and intended application of the laminate gasket 330.

FIG. 6D illustrates a laminate gasket 340 with a woven core layer 343 and having depressed regions 341 formed into the outer surfaces of both facing layers 344, 345 in relatively narrow strips proximate to and surrounding the aperture of the gasket 340. The depressed regions 341, which may be formed into the facing material through sanding or shaving techniques, can define tapered strips around the aperture of the gasket and result in an interior edge having a width less than the thickness of the laminate base sheet 342. The edge seal 346 is disposed on the edge and includes wrapped portions 348 that extend around and substantially cover the depressed regions 341 of the laminate base sheet 342. Further, in the illustrated embodiment, the wrapped portions 348 of the edge seal 346 protrude slightly beyond the outer surfaces of the facing layers 344, 345, although the wrapped portions might also lie substantially in and not protrude beyond the facial planes of the laminate gasket.

FIG. 6E illustrates a laminate gasket 350 with a woven core layer 353 and an edge seal 356 that wraps around and onto the outer surfaces of both facing layers 354, 355 to form face coatings 358 that extend in relatively narrow strips around the aperture of the gasket 350. The edge seal 356 is slightly bulbous in its mid portion and each of the wrapped face coatings 358 has a width measured in a direction parallel to its respective facial plane, and has a thickness. The thickness of each face coating may be selected to minimize any detrimental effect on the overall compression failure resistance of the gasket. It has been found that a thickness of the face coatings 358 in the range of from about 0.001 inch to about 0.011 inch forms a good seal without significantly degrading the compression failure resistance in regions of the gasket where compression failure resistance is a concern. In other regions, such as in the mid-span between bolt holes, the thickness of the face coating may range up to about 0.050 inch if desired. The width of the face coatings 358 may be from about 0.005 inch to about 0.6 inch depending on the size and intended application of the gasket. In any event, the face coatings generally do not cover no more than about 50 percent of its respective face and more preferably no more than about 30 percent, especially in regions of the gasket where compression failure resistance is of greatest concern.

FIG. 6F illustrates a laminate gasket 360 with a woven core layer 363 that is similar to the embodiment of FIG. 6C in that the upper facing layer 364 of the laminate base sheet 362 has a depressed region 361 that extends in a relatively narrow strip around the aperture of the gasket. In one aspect the depressed region 361 can be less than about 0.5 inches in width. The edge seal 366 is applied to the interior edge of the laminate base sheet 362 and has a height that extends from the opposite facing layer 365 to the lower corner of the depressed region 361. However, in contrast to the embodiment of FIG. 6C, the edge seal 366 does not extend beyond the lower corner of the depressed region 361 and thus does not form a face coating or a protruding rim around the aperture of the gasket 360.

FIG. 6G illustrates another embodiment of a laminate gasket 370 with a woven core layer 373 wherein the laminate base sheet 372 is provided with a uniquely configured edge seal 376. Similar to the embodiment of FIG. 6E, the edge seal 376 in FIG. 6G wraps around and onto the outer surfaces of both facing layers 374, 375 to form face coatings 378 that extend in relatively narrow strips around the aperture of the laminate gasket 370. The face coatings 378 have a thickness in regions where compression failure resistance is required that preferably is less than about 11 mils and a width that covers less than 50 percent and preferably less than 30 percent of outer surfaces of the facing layers 374, 375. Unlike the embodiment of FIG. 6E, however, the edge seal 376 in this embodiment protrudes beyond the facing layers 374, 375 and also protrudes beyond the face coatings 378 to form protruding rims 379 around the aperture of the gasket. Preferably, the rims 379 protrude beyond the face coatings 378 a distance from about 0.001 inch to about 0.040 inch, although other degrees of protrusion may be selected depending on the size and intended application of the gasket.

FIG. 6H illustrates yet another configuration of a possible edge seal on a laminate gasket 380 that embodies principles of the invention. In this embodiment, the edge seal 386 protrudes a distance D1 beyond the outer surfaces of both facing layers 374, 375 to form protruding rims 388. The edge seal 386 also has an interior surface that is substantially convex between the rims 388 such that the edge seal is substantially thicker in its mid-portion than at its ends. The maximum thickness of the edge seal from the edge of the laminate base sheet 382 to the interior surface of the edge seal is D2. It has been found that for an automotive gasket with a standard fraction thickness (e.g. 1/32 inch, or 0.031 inch), a distance D1 of between 0.001 inch to about 0.040 inch in conjunction with a distance D2 of between 0.001 inch to about 0.050 inch can be used depending on the size of the gasket and its intended application. More generally, it has been found that a ratio of distance D1 to distance D2 of between about 0.1 and 3 is preferred. The optimum values of D1 and D1 can vary greatly depending upon the conditions under which a seal must be established.

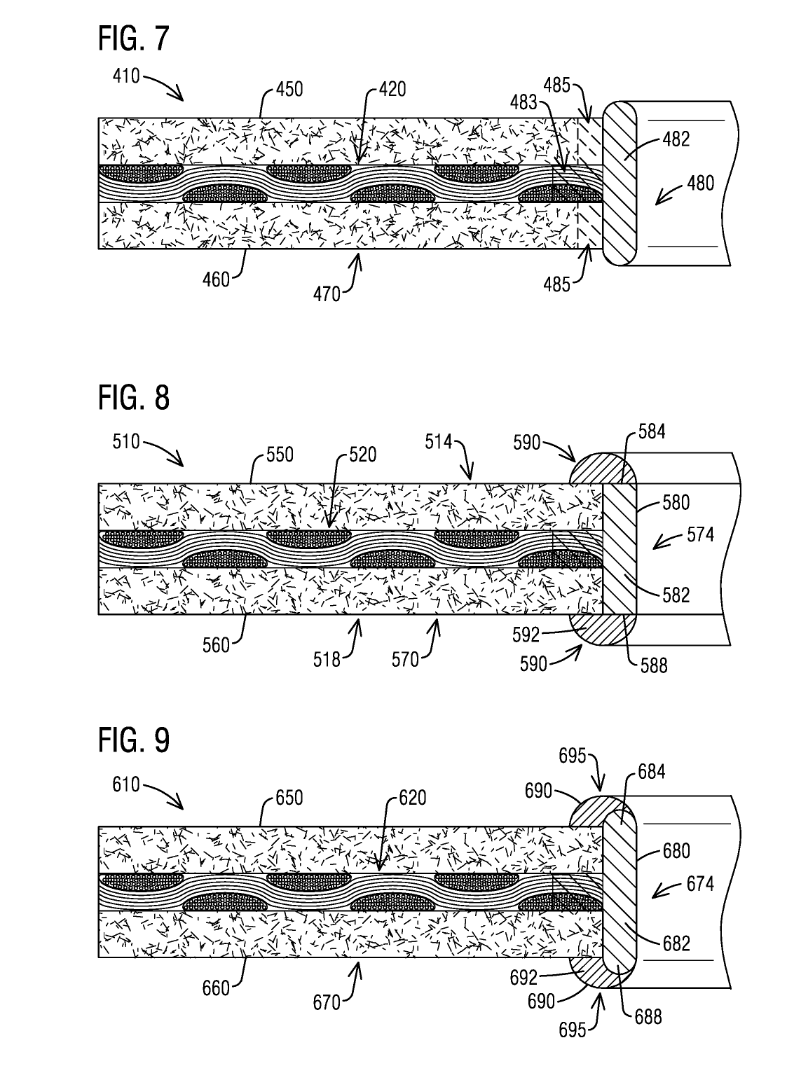

During one of more of the edge seal processes described above, it is possible that a portion of the edge seal material will penetrate into the inner edges of the base sheet to form intrusion zones. As shown with the laminate gasket 410 of FIG. 7, for example, a portion of the elastomeric material 482 that forms the edge seal 480 of the laminate gasket 410 can penetrate into the porous core layer 420 and form an intrusion zone 483. The intrusion zone 483 can act as a plug to further seal the core layer 420 against the pressurized process fluid that is contained by the laminate gasket 410. The intrusion zone 483 of edge seal material 482 can also become engaged with the woven fibers 432 within the core layer 420 upon the curing of the edge seal 480, thereby forming an interior anchor for the edge seal 480 that can further secure and strengthen the bond between the edge seal 480 and the laminate gasket material 470. Although the edge seal material 482 can preferentially penetrate into the porous core layer 420 of the laminate base sheet 470 to form the primary intrusion zone 483, in some embodiments the edge seal material 482 can also penetrate, to a lesser degree, into the less-porous or non-porous facing layers 450, 460 to form minor intrusion zones 485 that can be similarly beneficial.

In yet another embodiment of the laminate gasket 510 shown in FIG. 8, face seals 590 can be added to cover the facial surfaces 584, 588 of the edge seal 580 that have been formed substantially co-planar or flush with the facial surfaces of the laminate base sheet 570. In addition to the facial surfaces 584, 588 of the edge seal 580, the face seals 590 can also cover the portions of the upper surface 514 and lower surface 518 of the laminate base sheet 570 that are immediately adjacent the process aperture 574, as well as the interface between the laminate base sheet 570 and the edge seal 580. This can ensure that no process or service fluid contacts the outer surfaces of the facing layers 550, 560 (e.g. upper surface 514 and lower surface 518).

In one aspect the face seals 590 can be formed from an elastomeric material 592 that is different from the material 582 which forms the edge seal 580. Since the face seals 590 can be configured to provide the elastic sealing function against the two opposing surfaces that would otherwise be provided by the protruding rims of the edge seal, this feature can allow for the material 582 of the edge seal 580 to be specifically optimized to protect and seal the inner edge surfaces of the core layer 520 and the facing layers 550, 560 through increased resistance to chemical attack or degradation by the process or service fluid. Thus, it will be appreciated that in some embodiments the edge seal material 582 of the laminate gasket 510 can be less elastic or less compressible than that used in other embodiments of the laminate gasket described above, if so desired.

FIG. 9 is a cross-section of another embodiment of the laminate gasket 610 in which face seals 690 have been overlaid or combined with the protruding rims 684, 688 of the edge seal 680 to form composite protruding rims 695 that can be customized for a variety of applications. Here again, in addition to the protruding rims 684, 686 the face seals 690 can also cover the portions of the upper surface 614 and lower surface 618 of the laminate base sheet 670 that are immediately adjacent the process aperture 674, as well as the interface between the laminate base sheet 670 and the edge seal 680, to ensure that no process or service fluid contacts the outer facial surfaces of the facing layers 650, 660. In some aspects, the face seals 690 can be formed from the same material 692 as the edge seal material 682, only applied in a second process step so as to more precisely define the shape of the composite protruding rims 695. Alternatively, the elastomeric material 692 of the face seals 690 can be different from the elastomeric material 682 of the edge seal 680 to provide the laminate gasket 610 with composite protruding rims 695 having customizable compression characteristics. It will be appreciated that other shapes and material configurations for the composite protruding rims 695 are also possible and considered to fall within the scope of the present disclosure.

As indicated above, the invention has been described herein in terms of preferred embodiments and methodologies considered by the inventor to represent the best mode of carrying out the invention. It will be understood by the skilled artisan, however, that a wide range of additions, deletions, and modifications, both subtle and gross, may be made to the illustrated and exemplary embodiments of the composite substrate without departing from the spirit and scope of the invention. These and other revisions might be made by those of skill in the art without departing from the spirit and scope of the invention that is constrained only by the following claims.

What is claimed is:

1. A laminate gasket for sealing between two opposing surfaces, the laminate gasket comprising:
a core layer comprising:
a sheet of woven material having a first surface and a second surface opposite the first surface; and
a binder material impregnating the sheet and at least partially coating the first and second surfaces;
a first facing layer adhered to the first surface with the binder material and a second facing layer adhered to the second surface with the binder material to form a laminate base sheet, each of the first facing layer and the second facing layer comprising a fiber composite material;
at least one process aperture formed through the laminate base sheet; and
an edge seal formed around an inner edge of the process aperture to prevent interstitial leakage of a process fluid into the core layer.

2. The laminate gasket of claim 1, wherein the core layer is pervious to water vapor.

3. The laminate gasket of claim 1, wherein the core layer is impervious to water vapor.

4. The laminate gasket of claim 1, wherein the woven material further comprises woven fiberglass fibers.

5. The laminate gasket of claim 4, wherein the sheet of woven fiberglass fibers further comprises a fiberglass cloth.

6. The laminate gasket of claim 5, wherein the fiberglass cloth further comprises woven strands formed from bundled fiberglass fibers.

7. The laminate gasket of claim 4, wherein the sheet of woven fiberglass fibers has a tensile strength of at least about 10,000 psi.

8. The laminate gasket of claim 1, wherein a thickness of the core layer is between about 0.005 inches and about 0.010 inches.

9. The laminate gasket of claim 1, wherein the binder material further comprises an acrylic latex.

10. The laminate gasket of claim 1, wherein a thickness of each of the first facing and the second facing is between about 0.005 inches and about 0.010 inches.

11. The laminate gasket of claim 1, wherein the fiber composite material further comprises 15-20% rubber latex, about 20% fiber material, and about 60% clay filler material.

12. The laminate gasket of claim 1, wherein the edge seal protrudes outwardly beyond an outer surface of at least one of the first facing layer and the second facing layer.

13. The laminate gasket of claim 1, wherein the edge seal further comprises an elastomeric material selected from the group consisting of a polymeric material and a rubber latex material.

14. A laminate gasket for sealing between two opposing surfaces, the gasket comprising:
a core layer comprising:
a cloth formed from woven fiberglass and having a first surface and a second surface opposite the first surface; and
a binder material impregnating the cloth and at least partially coating the first and second surfaces;
a first facing layer adhered to the first surface with cured binder material and a second facing layer adhered to the second surface with cured binder material to form a laminate base sheet, each of the first facing layer and the second facing layer comprising a fiber composite material;
at least one process aperture formed through the laminate base sheet; and
an edge seal formed around an inner edge of the process aperture to prevent interstitial leakage of a process fluid into the core layer,
wherein the core layer is pervious to water vapor.

15. The laminate gasket of claim 14, wherein a thickness of the core layer is about 0.007 inches and a thickness of each of the first facing and the second facing is about 0.009 inches.

16. The laminate gasket of claim 14, wherein the fiber composite material further comprises a mixture comprising 15-20% rubber latex, about 20% fiber material, and about 60% clay filler material.

17. The laminate gasket of claim 14, wherein the edge seal protrudes outwardly beyond an outer surface of at least one of the first facing layer and the second facing layer.

18. The laminate gasket of claim 14, wherein the edge seal further comprises an elastomeric material selected from the group consisting of a polymeric material and a rubber latex material.

19. A method of making a laminate gasket for sealing between two opposing surfaces, the method comprising:
obtaining a sheet of woven fiberglass fibers having a first surface and a second surface opposite the first surface;
impregnating the sheet with a wet binder material comprising an acrylic latex to at least partially coat the first and second surfaces;
applying a first facing layer formed from a fiber composite material to the first surface;
applying a second facing layer formed from the fiber composite material to the second surface;
heating the sheet and the applied first and second facing layers to a first predetermined temperature for a first predetermined time to cure the binder material and form a sheet of laminate gasket material;
cutting a laminate base sheet from the sheet of laminate gasket material, the laminate base sheet having at least one process aperture and a plurality of bolt holes;
forming an edge seal on an inner edge of the at least one process aperture; and
cutting away an outer portion of the laminate base sheet to define the outer dimensions of the laminate gasket.

20. The method of claim 19, wherein forming the edge seal further comprises:
stacking together a plurality of laminate base sheet while aligning together the process apertures of the laminate base sheets to define a cavity within the stack of laminate base sheets;
introducing a wet and flowable edge seal material into the cavity;
rotating the stack of laminate base sheets to deposit the wet edge seal material onto the inner edges of the process apertures;
separating the plurality of laminate base sheets; and
heating the plurality of laminate base sheets to a second predetermined temperature for a second predetermined time to cure the wet edge seal material.
